(19) United States
(12) Patent Application Publication
(10) Pub. No.: US 2010/0191728 A1
(43) Pub. Date: Jul. 29, 2010

(54) Method, System Computer Program, and Apparatus for Augmenting Media Based on Proximity Detection

(76) Inventors: James Francis Reilly, Helsinki (FI); Jukka Sakari Alakontiola, Oulu (FI); Kristian Andreas Luoma, Kiviniemi (FI); Kui Fei Yu, Beijing (CN); Jian Ma, Beijing (CN)

Correspondence Address: Hollingsworth & Funk, 8500 Normandale Lake Blvd., Suite 320, Minneapolis, MN, 55437, US

(21) Appl. No.: 12/358,581

(22) Filed: Jan. 23, 2009

(51) Int. Cl. G06F 17/30

(52) U.S. Cl. 707/736; 707/E17.019

(57) ABSTRACT

Augmenting media based on proximity detection involves detecting proximate devices of participants of an event via a wireless proximity device. User media associated with the participants is obtaining based on the proximity detection and further based on contact data associated with the participants. Event media that records an aspect of the event is obtained the event media is combined with the user media to form augmented media, wherein the augmented media simulates the participant's presence in the event media.

### TECHNICAL FIELD

This specification relates in general to computer applications, and more particularly to systems, apparatuses, computer programs, and methods for augmenting media based on proximity detection.

### BACKGROUND

Consumers are increasingly utilizing digital media capture to document their life experiences. The cost of digital camera technology has rapidly decreased to the point where digital cameras are the mainstream choice for most users' photo needs. Further, the ubiquity of digital cameras and the like is increasing due to this technology being included on always-available personal communication devices such as cell phones and personal digital assistants (PDAs). As the ability to capture ever more media increases, the documentation of such media becomes more important. Most media can at least be identified by a date, such as by a creation timestamp embedded in the media or the creation time of the media file itself.

Oftentimes, the time and date is insufficient to help users determine to what the media pertains to. After a significant passage of time, a person's memory of the event may fade, and some media captured may be unrecognizable without other clues, such as the social context in which the media was captured. The social context may include any descriptive information of sentimental or social interest to the persons who take or view the photos. Examples of social context may include who was present when media was captured, where the media was captured, what events were going on at the time, etc.

Associating social context with media may also be useful when media is shared online. For example, online social network services are becoming very popular with many segments of the population. Some members regularly upload their status, post comments, and share their experience with their friends. Participants in social networks increasingly include photos as part of their personal pages. Some Internet communities are primarily based on photo sharing (e.g., Flickr™) while other social network services facilitate using such photos as part of a broader goal of establishing and maintaining social relationships between people.

### SUMMARY

The present specification discloses systems, apparatuses, computer programs, data structures, and methods for augmenting media based on proximity detection. In one aspect, apparatuses, computer-readable medium, and methods for augmenting media based on proximity detection involve detecting proximate devices of participants of an event via a wireless proximity device. User media associated with the participants is obtaining based on the proximity detection and further based on contact data associated with the participants. Event media that records an aspect of the event is obtained the event media is combined with the user media to form augmented media, wherein the augmented media simulates the participant's presence in the event media.

In one aspect, the event media includes a digital photograph of the event, and the user media includes digital images of the participant that is obtained independently of the digital photograph. In such a case, a template may be obtained that supplements one or more of the digital images of the participants.

In any of the above aspects, metadata may be embedded into at least one of the event media and the augmented media. The metadata may be obtained from at least one of the proximity detection and the contact data. The metadata may further include a computer-processable reference to an information feed that facilitates associating user-editable comments with at least one of the event media and the augmented media.

In any of the above aspects, obtaining the user media may involve obtaining the user media directly from the proximate devices using near field communications and/or obtaining the user media from a network service.

These and various other advantages and features are pointed out with particularity in the claims annexed hereto and form a part hereof. However, for a better understanding of variations and advantages, reference should be made to the drawings which form a further part hereof, and to accompanying descriptive matter, in which there are illustrated and described representative examples of systems, apparatuses, computer program products, and methods in accordance with example embodiments of the invention.

### BRIEF DESCRIPTION OF THE DRAWINGS

The invention is described in connection with example embodiments illustrated in the following diagrams.

FIG. 1 is a block diagram illustrating a use case scenario according to an example embodiment of the invention;

FIG. 2 a block diagram illustrating use of templates according to an example embodiment of the invention;

FIG. 3 is a block diagram illustrating a data structure according to an example embodiment of the invention;

FIGS. 4 and 5 are a block diagrams illustrating network communication of augmented media according to an example embodiment of the invention;

FIG. 6 is a block diagram of a user apparatus according to an example embodiment of the invention;

FIG. 7 is a block diagram of a service apparatus according to an example embodiment of the invention; and

FIGS. 8-9 are flowcharts illustrating procedures according to example embodiments of the invention

### DETAILED DESCRIPTION

In the following description of various example embodiments, reference is made to the accompanying drawings that form a part hereof, and in which is shown by way of illustration various example embodiments. It is to be understood that other embodiments may be utilized, as structural and operational changes may be made without departing from the scope of the present invention.

Generally, the present disclosure is related to enhancing media capture using detected identity data that describes a group of users and/or other entities. In one arrangement, one or more apparatuses may be configured to automatically form a group of users based on a common context (e.g., physical proximity, registration to a common service, attendance at a common event, etc.). The apparatus may capture media (e.g., digital photo or video) and further gather media associated with the group members. The gathered media is then combined with the captured media to form enhanced/augmented media. For example, digital photos taken on a tour group can be modified to include photo representations of individuals associated with the tour group. In this way, the photo can commemorate not only a place on the tour, but individuals who were present on the tour, even if those persons were not immediately available when the photo was taken.

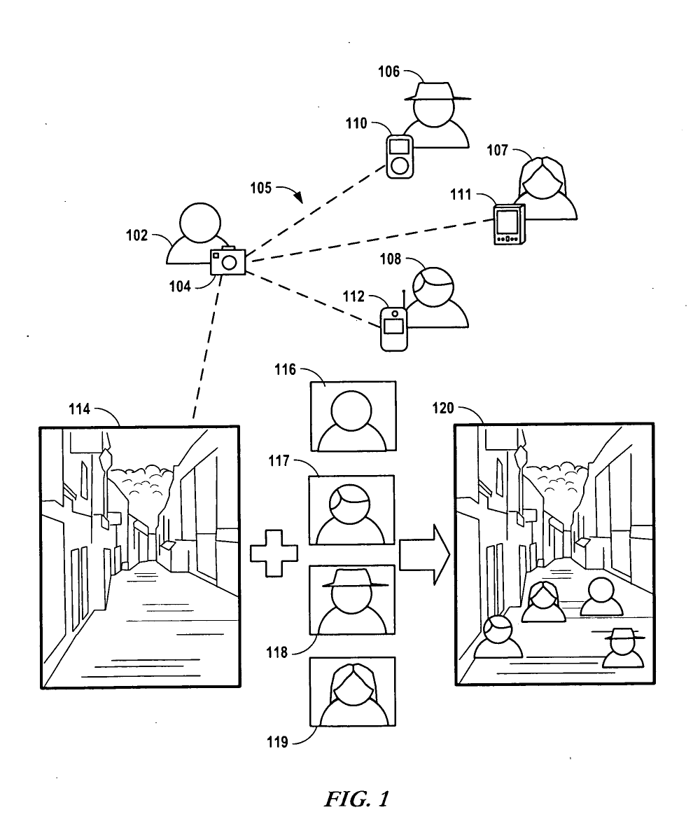

A block diagram in FIG. 1 illustrates a use case for creating augmented media according to an example embodiment of the invention. A user 102 may utilize one or more mobile devices 104, such as a digital camera, cellular phone, etc., that is capable of capturing media. In many of the examples described herein, the captured and augmented media is visual (e.g., photos, video). These concepts may be also applicable to other user-captured and user-provided media, including audio, sensory data, metadata, etc. The user 102 in this scenario is attending an event (e.g., a training session) with some of his/her colleagues from all over the world, as represented by individuals 106-108. These colleagues 106-108 may each have respective mobile devices 110-112 that enable automatic detection of the identities of the colleagues 106-108 by user 102. Such detection may occur via user device 104, and may occur at a time and place consistent with the event to which the captured media pertains. In this example, the detection of the colleagues 106-108 may occur at some point during the training session, and may be used to augment data captured in connection with the training session, such as to created augmented media 120.

During the session, user 102 takes many pictures of the venue using device 104, as represented by digital picture 114. Although in this scenario the picture 114 is described as being taken by device 104, in other scenarios a similar result can be obtained even if the device 104 does not have photo capability. For example, picture 114 may be obtained using a location-based picture search feature to find a ready-made picture, e.g., by downloading a previously taken picture over a network. Such a ready-made picture may be desirable even where device 104 has the ability to capture pictures, such as when it is too dark to take a photo, inclement weather degrades the ability to take a picture, downloaded picture higher quality is higher quality that device capability, etc. The picture 114 may also be obtained from one of the other devices 110-112, e.g., via peer-to-peer file sharing.

However the picture 114 is obtained, it may often be the case that the user 102 has no opportunity to gather all the attendants 102, 106-108 together for a group photo. To account for such a situation, the mobile device 104 has the ability to scan for nearby friends, as represented by paths 105. This scan 105 may occur contemporaneously with taking of a picture 114 and/or at some other reasonably proximate time/place. In this scenario, the scan 105 finds devices 110-112, and thereby enables determining the identities of associated persons 106-108. These identities are used in creating the augmented media 120.

The moment/period of time in which the scan 105 occurs may be defined in a flexible manner to suit the occasion at hand. Generally, these occasions may include social occasions such as meetings, conferences, holidays, parties, vacations, festivals, etc. The location may also be taken into account when determining the scan 105. For example, as mentioned above, the proximity of the user devices 104, 110-112 may be taken into account when deciding to form augmented media 120. In some situations, the absolute location of users and devices may further be taken into account. In one example, the formation of the augmented data 120 may be triggered when one of more of the devices 104, 110-112 are in certain predefined geolocations.

The scan 105 may also result in a determining supplementary media associated with the individuals 102, 106-108, here represented as photos 116-119. This supplementary media 116 may be obtained by any combination of downloading directly from devices 104, 110-112 in response to the scan 105, finding locally stored images on user device 104 (e.g., from a contacts database), and/or utilizing some third party service (e.g., network service; not shown).

The supplementary media 116-119 can be associated with any media 114 produced and/or obtained via device 104 for further processing. This association may be manually triggered by user 102 (or other users 106-108) for each item of captured/primary media 114 being processed. In other cases, the media 114, 116-119 may be associated automatically via the device 104 based on a proximity in time, location, etc. In such a case, scan 105 may occur contemporaneously with capturing/obtaining the image 114. In another arrangement, a third party service (not shown) may set the criteria for associating the media 114, 116-119. For example, the scan 105 may discover a local kiosk (not shown) that facilitates printing of photos processed as described below, and the kiosk causes the media 114, 116-119 to be associated for further processing, either via the device 104 of via the kiosk.

After user 102 has found colleagues 106-108 via the scan and at least one picture 114 has been determined, the picture 114 can be used as a background for pictures 116-119 to form composite image 120. In the illustrated composite image 120, the faces of the individuals from pictures 116-119 are overlaid on some portion of the scene from picture 114. In other arrangements, the pictures 116-119 may be added as a border, header, footer, etc., that surrounds some portion of the main picture. The pictures 116-119 may include a transparent background to facilitate this combination with image 114, or post-processing such as border detection may be applied to obtain a similar result. In one variation, the relative location of the users 106-108 to the person 102 (e.g., as determined by respective devices 104, 110-112 at a time when media 114 is captured/obtained) may be taken into account when forming augmented media 120. For example, photos 117-119 of individuals 106-108 may be scaled relative to their distance from person 102 who captures/obtains media 114. Other enhancements in making the composite picture 120 are discussed in greater detail hereinbelow.

The pictures 116-119 may be obtained directly from devices 104, 110-112, such as may be stored in vCard info for each of the persons 102, 106-112. A vCard is an electronic file having a standard format that facilitates exchanging contact information (e.g., names, addresses, phone numbers, URLs, logos, photographs, audio clips, etc.). Contact image data may be passed using other file formats, e.g., eXtensible Markup Language (XML)-based formats such as hCard and XML vCard. In other arrangements, such data may be obtained via network-based services, such as social networking Web sites. A vCard (or other user data) could be configured to hold a picture specifically for this purpose, such as having a transparent background, having multiple views (e.g., side, front), having metadata that locates key features (e.g., face boundaries, location of eyes, nose, mouth, etc.). Such specially adapted features may facilitate adding additional features in the augmented media 120, such as facilitating animating faces, e.g., in combination with user-supplied audio clips. Similarly, in lieu of pictures a video clip may be provided that can be adapted in a similar manner to photos.

The scan 105 that obtains the personal information from devices 110-112 can be performed in a number of ways. For example, device 104 may scan for any combination of nearby Bluetooth Media Access Control (MAC) addresses, Wireless Local Area Network (WLAN) MAC addresses, Radio Frequency Identifier (RFID) tags/transponders, shared location presence, etc. In other arrangements, the device 104 may retrieve equivalent data from a network service (not shown) that shows current absolute location for various devices 110-112, such as via collecting Global Positioning Satellite (GPS) data, using cell phone base station location estimation, WiFi hotspot location estimation, etc.

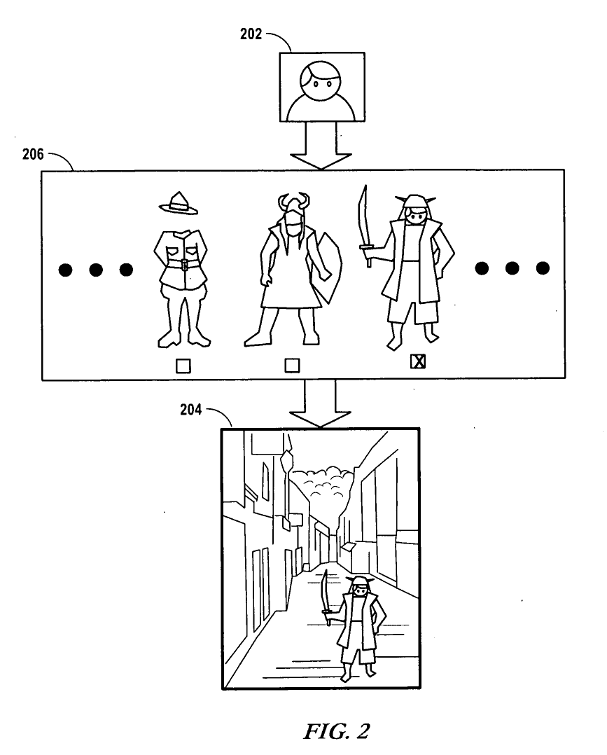

In reference now to FIG. 2, and block diagram illustrates enhancements that may be used in methods, systems, and apparatuses according to an example embodiment of the invention. As in FIG. 1, a media sample 202 (e.g., photo) associated with a participant is obtained in response to a media capture event, and combined with captured/obtained media (e.g., photo 114) to create augmented media 204. In addition, a template feature 206 may be accessed to further enhance the augmented media 204. In this example, the templates 206 include graphical overlays that may be selected and combined with sample 202 to add interest to the resulting augmented media 204.

The templates 206 may include bodies and/or costumes that are positioned with the media sample 202 of the participant. A database of such templates may be searchable based on user preferences, and/or may be made more prominent depending on the current locale (e.g., “Mountie” in Canada, “Viking” in Norway, “Samurai” in Japan). The event location, landmark, and/or relevant keywords may be used as a search inputs. Such searches results may be obtained automatically while on location and/or manually before or after media associated with an event is captured/obtained. Templates 206 can be made available ready-made by vendors, e.g., in return for payment. In other cases, businesses may entice customers by providing free templates 206 to promote business interests, such as by selling printouts of the augmented images. In other cases, the templates may be provided in return for allowing advertising to be inserted in the image, e.g., by use of a non-intrusive logo and/or hyperlink. Such templates 206 may be advertised locally using wireless technologies, e.g., a local kiosk that advertises templates and other services (e.g., media printout) at popular tourist spots.

The augmented media 120, 204 shown in FIGS. 1 and 2 may at least involve combining supplementary personal media data (e.g., photos derived from contacts data) with primary data (e.g., photo taken on-location). As seen in media 120, 204, this combination may involve placing two-dimensional overlays on a digital photo image. The two dimensional images may purposely appear two-dimensional, or may be made to appear three-dimensional. For example, individual representations of people may be placed and scaled to give the illusion of perspective in the scene. In other cases, the personal images may be made to appear overlaid onto surfaces, such as appearing to be wallpaper or placed onto flat signs. In other arrangements, user images may be animated to simulate motion, and this animation may be augmented with sound (e.g., speech).

The augmentation may also involve adding other data that may be derived from user devices. For example, the augmented photos 120, 204 may be prepared in an electronic format with portions of the photo selectable and hyperlinked. These links may be used, for example, to access personal/business Web pages of participants added to the picture, advertise businesses visible in the picture, etc. Other data, such as sounds, text, and the like may be added to the augmented media, for purposes such as delivering customized messages/commentary of one or more of the participants. Metadata (e.g., text) may also be embedded in the augmented image for similar purposes.

As previously described above, user data is derived from groups of individuals that are participating in an event. The groups may be dynamically and automatically created by using proximity detection, e.g., by detecting Bluetooth/WLAN MAC addressing. The detected addresses or other proximity data can be used to obtain supplementary data that is used as part of augmented media formation. In such a case, there may need to determine a mapping between device identifiers and user identities. There may not always be a one-to-one mapping of user IDs to device IDs (e.g., user may have more than one device) and such mappings may change over time (e.g., user obtains new device or signs in to a device that is associated with multiple users). Also, for privacy reasons, users may not want their identities publicly identifiable via proximity detection without some form of authorization and/or authentication.

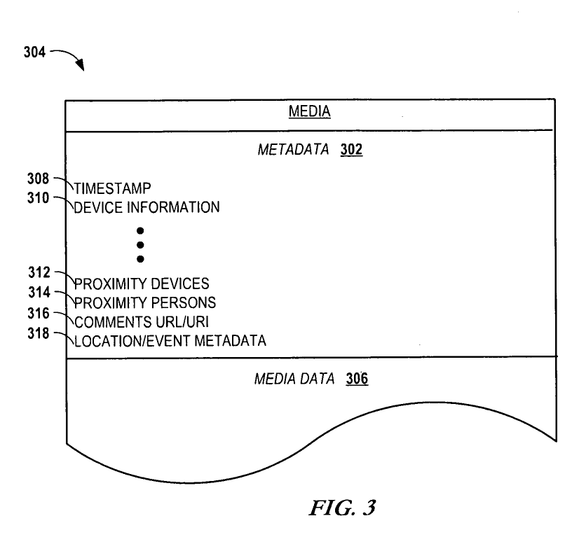

In reference now to FIGS. 3-5, block diagrams illustrates a system that can facilitate group formation according to an example embodiment of the invention. This group formation can be used to gather data that is embedded in captured media to link the media to a social context in which the media was captured. The social context may include the identity of persons related to the photo. Such persons may include persons in or around the photo when the photo was captured/obtained, and persons who review or leave comments regarding the photo.

In FIG. 3, a block diagram illustrates metadata 302 embedded into media 304 according to an example embodiment of the invention. The media 304 may include a file, stream, or other encapsulation of data, and includes a media portion 306 that is targeted for rendering to a user interface. Examples of media data 306 include binary representations of captured photos, video, audio, or any other data (e.g., movement, tactile, olfactory) that may be rendered to a person. The media data 302 may also include data such as text and vector graphics that, while possibly not formed via sensor input, can be combined for rendering along with sensed data.

The metadata 302 may be encapsulated with the media data 306, but may not be intended for direct rendering to the user with the media data 306. Many devices embed data such as date/time 308 and device information 310 (e.g., model, resolution, color depth, etc.). For purposes of associating media 304 with social context, three fields or tags may be added to the metadata section 302: proximity devices 312, proximity persons 314, and comments Uniform Resource Locators (URLs)/Uniform Resource Identifiers (URIs) 316. These metadata entries 312, 314, 316 may be of the type “string list,” e.g., a list/collection of character strings.

The proximity devices field 312 may be in the form of “protocol:addressValue.” This field 312 can be filled with device address such as MAC address, Bluetooth address, RFID codes, etc., detected by the device which is capturing/obtaining the media 304. The proximity persons field 314 may be in the form of “socialNetworkName: username.” The social network service name may include a standard identifier for a particular social network (e.g., MySpace™, Facebook™, Ovi™) plus the person's user name/identifier on that social network.

The comments URL/URI 316 may include an address that facilitates viewing/adding comments related to the photo generated in social network services. For example, a URL may reference an Atom Feed that facilitates annotating media 304. The term “Atom” may refer to and combination of Atom Syndication Format and Atom Publishing Protocol (AtomPub or APP). The Atom Syndication Format is an XML language used for web feeds. AtomPub is an HTTP-based protocol for creating and updating web resources. Similar functionally may be provided by forming a URL/URI 316 to access other information feed technologies, such as Really Simple Syndication (RSS).

Other data that might be useful in correlating the media 304 with other data of a social network is represented as location/event metadata 318. This data 318 may include absolute indicators of location (e.g., cellular base station identifier, geolocations, etc.) and/or other data that may tie the media 304 to a particular place and/or event (e.g., city, country, street name, building name, postal code, landmark name, event name, etc.). In one example of how this data 318 may be used, assume that two or more people attend an event together and each capture media of the event having timestamps 308 and location/event identifiers 318 that can be later be correlated to a common event. If the individuals are members of a social networking service and have an established relationship (e.g., strong bidirectional friend relationship) the captured media can be correlated to strongly infer that we are at the same event (location 318 and timestamp 304).

Because of the previously established relationship on the social networking service, the service may provide indicators of this correlation. For example, a photo with detected but unidentified individuals may provide the option to “add X to this photo?” In other cases, the individuals may see an option to link the other's media to their own shared collection based on the media being captured at the same event. This may occur even if the individuals did not know the other had attended the event, and may be a useful tool in maintaining relationships established via the service. In other cases, the service may be able to extend relationships based on close correlation between media. For example, the service may prompt a user with “You may know X based on attendance of event Y with your friends A and B,” and thereby facilitate adding X to the user's friend list. Such indicators may be particularly relevant of X, A, and B were all tied to the same media via proximity detection as described elsewhere herein.

Such a bidirectional relationship in a social networking service as described above might be used to augment the collection of proximity and contact data (e.g., metadata 312, 314, 316). In such a case, if someone's contact data isn't available via a proximate device, the online relation can established a “suggested possibility” based on other data (e.g., time 308, location 318). For example, if user A's photo at an event can be matched to user B and C via proximity detection, and user D's photos can be matched to user B, C, and E via proximity detection at the same event, then group photos taken by user A and D may be linked to all users A-E, assuming the time and location are matched close enough to make this correlation likely (e.g., within a few seconds in time and within a meter of distance). This correlation may be presented to the users as a suggested possibility rather than automatically added to account for coincidences (e.g., many photos being taken at the same place and the same time).

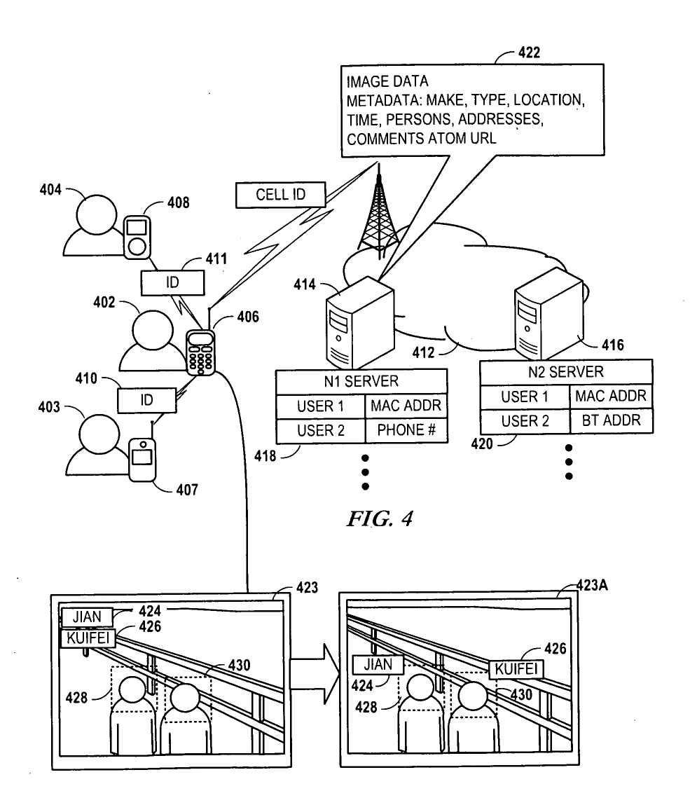

In reference now to FIG. 4, a block diagram illustrates how proximity detection can be used to form embedded metadata for enhancing content according to an example embodiment of the invention. Similar to the scenario in FIG. 1, users 402-404 with respective devices 406-408 are present in some social context. Device 406 may be configured to capture/obtain media relevant to the social context, e.g., device 406 may include a camera. Device 406 may also include a functional component, e.g., a context sensor and/or near-field communication (NFC) device, that detects proximate users and other relevant data, thereby enabling adding the social context to media captured by device. It will be appreciated that some of the media capture and social context capture functions may be cooperatively distributed between multiple devices 406-408, and the descriptions herein of device 406 performing these functions is for purposes of illustration, and not of limitation.

When capturing a media, the NFC-enabled device 406 may sense other NFC-enabled devices 407, 408 around it. This is represented by communication of device identifiers 410, 411, which may include any combination of WLAN MAC addresses, Bluetooth addresses/names, RFID identifiers, and/or other identifiers of devices 407, 408. After the device 406 senses the other proximate devices 407, 408, the device 406 (or some other entity) can associate the proximity devices identifiers 410, 411 with media captured by the device 406. This data 410, 411 may be formatted as proximity devices metadata 312 as seen in FIG. 3.

The device 406 may also attempt to fetch identity information (e.g., names) of owners associated with device IDs 407, 408. For example, the local contacts database (not shown) of device 406 can be searched by each “protocol: address” in the proximity devices list. If a match found, add the owner's name as a proximity person (e.g., metadata 314 in FIG. 3) in the form “local:name,” where “local” is a predefined identifier for personally maintained contacts. These local contacts may be considered analogous to a social networking service.

If a match is not found on a local contacts database, the device 406 may exchange messages directly with devices 407, 408 to obtain identity data associated with devices IDs 407, 408. If such data is available, the identity data can be added to the local contacts database of device 406 and/or the identity data can used to form proximity person metadata in the form of “local: name.”

If a match cannot be found on devices 406-408, the device 406 may search via a network 412 to obtain identity data associated with the device IDs 407, 408. Such data may be available from social networking services 414, 416 that maintain respective user databases 418, 420. The user name can be searched by “protocol: address” in each service 414, 416. If a match found, the owner's identity data is added as a proximity person (e.g., metadata 314 in FIG. 3) in the form “servicename:username.” Assuming the metadata is available relating to one or both of the proximate device and proximate person, the metadata can be cached and/or embedded in media captured/obtained by device 406.

The device 406 may use the proximate device and proximate person metadata to perform further processing on the captured media, such as by creating an augmented image as described in relation to FIGS. 2-3. Images of other users, as well as other enhancements such as templates, may be obtained locally from device 406, directly from proximate device 406-408, and/or via network services 414, 416.

Another example of how the identity metadata may be used is seen in view 423. This view 423 may be presented, for example, in a viewfinder of device 406 when a picture is being taken, or sometime thereafter. The proximity detection results in two labels 424, 426 being displayed that may correspond to two individuals (e.g., 403, 404) who are in the picture. The device 406 may also have image analysis capability (e.g., face recognition) that can highlight areas 428, 430 of the picture 423 where persons are present.

The viewfinder of device 406 may have capabilities (e.g., a touchscreen) that allow the user 402 to move the labels 424, 426 to the respective highlighted areas 428, 430 to identify the individuals 403, 404 in the picture, as seen in view 423A. The resulting captured image may include these 424, 426 and respective highlighted areas 428, 430 as any combination of embedded metadata and image overlays. These components 424, 426, 428, 430 may be interactive in the resulting electronic image. For example, a “mouse over” type event may cause the highlighted areas 428, 430 to become visible in the image, and a selection event of highlighted areas 428, 430 may cause labels 424, 426 to be displayed.

The user 402 may also wish to share annotated and/or augmented images with the community. For example, the media can be sent to the one or more sharing services 414, 416, as represented by shared media data 422 available via service 414. Many image sharing communities currently provide URLs pointing to feeds, such as Atom and RSS feeds, that facilitate commenting on photos and other media. In such a case, the service providers can provide a URI/URL pointing to a comments tag. In the illustrated case, a URI/URL may be determined by the service 414 receiving the media, and the service 414 embeds the URL/URI into data 422. In alternate arrangements, the URI/URL can be provided to the device 406 from one or more services 414, 416, and the URI/URL can be embedded with the data 422 locally before being sent to various services 414, 416.

Users of services 414, 416 can use the enhanced metadata in other ways, such as manipulating/modifying the media via the Web page based on the embedded metadata, visiting the profile of persons depicted in the media renderings, sending messages (e.g., within or between social networks) to persons depicted in the media renderings, and/or searching pictures having the same person(s). Also, as described above in relation to FIG. 3, other metadata such as time and location (e.g., 308, 318) that are embedded in the media can be used to extend the correlation between media items and relationships established via service 414, 416.

For example, where user proximity is not detected by some media capture devices, but proximity data is detected by other media capture devices at the same event, the time and location of the captured media may be analyzed in conjunction with bidirectional relationships of services 414, 416 to fill in missing data (e.g., name of persons in a group photo). Similarly, missing data may be determined where no proximity of a particular user is detected by any media capture devices, such as where the particular had proximity detection disabled. However, if that particular user captured and uploaded media to the services 414, 416 that includes time and location data that correlates closely to the other persons at the event, then the system may be able to associate the user with others who attended the event and also submitted media augmented with proximity social context data. In such a case, if that particular user has an established bidirectional relationship with any of the proximately detected individuals, then that person may be optionally included in the social context of particular media items correlated by time and locations. In other cases, the particular user may be associated with all media items captured at an event, if appropriate.

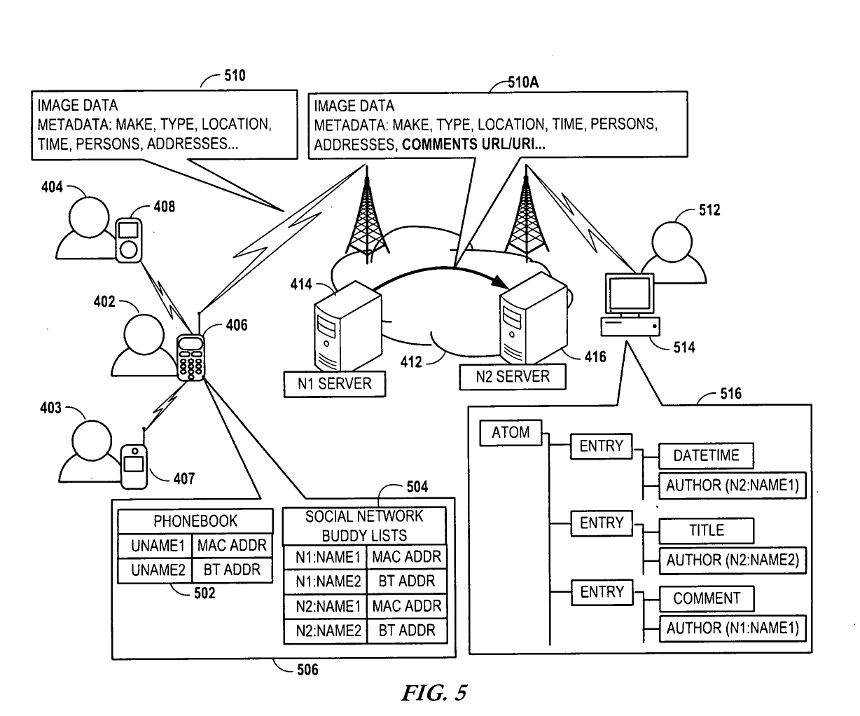

In reference now to FIG. 5, a block diagram shows a more detailed example of annotating media, where the same reference numbers are used indicate analogous components as shown in FIG. 4. Generally, the device 406 has captured media and detected proximate device identifiers, e.g., from devices 407, 408 and others. A local lookup of a contacts database of device 406 provides results shown in listing 502. A network query of services 414, 416 using device identifiers results in listing 504. These listings 502, 504 collectively represent at least part of social context data 506 that augments the media. The social context data 506 may include other data not shown, such as location data, event/occasion identifiers, supplementary media, etc.

The social context data 506 can be embedded in media 510 by device 406. The media 510 is then sent via network 412 to service 414, which adds comments URL/URI to form augmented media 510A. This media 510A is then passed to service 416, where an additional URL/URI may be added. Because the media 510A may be passed between numerous services, the services may add additional URLs to the comments URL tag, but may be restricted from modifying or deleting existing tags.

Eventually, the media may be rendered to a viewer 512 via apparatus 514, such as by accessing one of the sharing services 414, 416. The multiple comments URL may result in an aggregated feed 516 that contains annotations added by participants of one or more sharing services. As each comment has an author, management software can deduce persons who may interested in this media 510A by parsing the RSS feed collected from different service providers.

For example, a number of photos may be augmented and/or annotated as being related to an event and associated with a group of individuals that attended the event, e.g., via proximity detection. The individuals associated with the group may be able to automatically view and comment on those photos. In some cases, members of the group may also have taken other photos (or captured other media) in association with the event but did not associate these other photos with the group members. By correlating certain data associated with those other photos (e.g., time, place, event name) with the group-associated photos, those other photos might be recommended to others of the group who may not have been aware of this additional content.

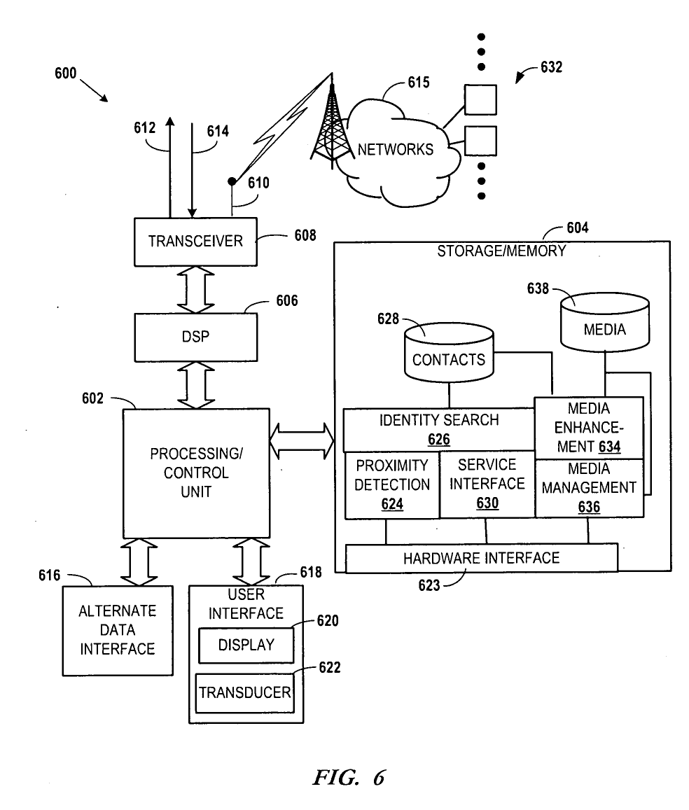

Many types of apparatuses may be used for proximity group detection, image capture, and/or image augmentation as described herein. For example, users are increasingly using mobile communications devices (e.g., cellular phones) as multipurpose mobile computing devices. In reference now to FIG. 6, an example embodiment is illustrated of a representative user computing arrangement 600 capable of carrying out operations in accordance with an example embodiments of the invention. Those skilled in the art will appreciate that the example user computing arrangement 600 is merely representative of general functions that may be associated with such user apparatuses, and also that fixed computing systems similarly include computing circuitry to perform such operations.

The user computing arrangement 600 may include, for example, a mobile computing arrangement, mobile phone, mobile communication device, mobile computer, laptop computer, desk top computer, phone device, video phone, conference phone, television apparatus, digital video recorder (DVR), set-top box (STB), radio apparatus, audio/video player, game device, positioning device, digital camera/camcorder, and/or the like, or any combination thereof. Further the user computing arrangement 600 may include features of the user apparatuses shown in FIGS. 1 and 4-5, and may be used to display user interface views as shown in FIGS. 1-2.

The processing unit 602 controls the basic functions of the arrangement 600. Those functions associated may be included as instructions stored in a program storage/memory 604. In an example embodiment of the invention, the program modules associated with the storage/memory 604 are stored in non-volatile electrically-erasable, programmable read-only memory (EEPROM), flash read-only memory (ROM), hard-drive, etc. so that the information is not lost upon power down of the mobile terminal. The relevant software for carrying out mobile terminal operations in accordance with the present invention may also be provided via computer program product, computer-readable medium, and/or be transmitted to the mobile computing arrangement 600 via data signals (e.g., downloaded electronically via one or more networks, such as the Internet and intermediate wireless networks).

The mobile computing arrangement 600 may include hardware and software components coupled to the processing/control unit 602 for performing network data exchanges. The mobile computing arrangement 600 may include multiple network interfaces for maintaining any combination of wired or wireless data connections. The illustrated mobile computing arrangement 600 includes wireless data transmission circuitry for performing network data exchanges. This wireless circuitry includes a digital signal processor (DSP) 606 employed to perform a variety of functions, including analog-to-digital (A/D) conversion, digital-to-analog (D/A) conversion, speech coding/decoding, encryption/decryption, error detection and correction, bit stream translation, filtering, etc. A transceiver 608, generally coupled to an antenna 610, transmits the outgoing radio signals 612 and receives the incoming radio signals 614 associated with the wireless device. These components may enable the arrangement 600 to join in one or more communication networks 615, including mobile service provider networks, local networks, and public networks such as the Internet and the Public Switched Telephone Network (PSTN).

The mobile computing arrangement 600 may also include an alternate network/data interface 616 coupled to the processing/control unit 602. The alternate data interface 616 may include the ability to communicate via secondary data paths using any manner of data transmission medium, including wired and wireless mediums. Examples of alternate data interfaces 616 include USB, Bluetooth, RFID, Ethernet, 602.11 Wi-Fi, IRDA, Ultra Wide Band, WiBree, GPS, etc. These alternate interfaces 616 may also be capable of communicating via the networks 615, or via direct and/or peer-to-peer communications links. As an example of the latter, the alternate interface 616 may facilitate detecting proximately-located user devices using near field communications in order to supplement media with social context data.

The processor 602 is also coupled to user-interface hardware 618 associated with the mobile terminal. The user-interface 618 of the mobile terminal may include, for example, a display 620 such as a liquid crystal display and a transducer 622. The transducer 622 may include any input device capable of receiving user inputs. The transducer 622 may also include sensing devices capable of producing media, such as any combination of text, still pictures, video, sound, etc. Other user-interface hardware/software may be included in the interface 618, such as keypads, speakers, microphones, voice commands, switches, touch pad/screen, pointing devices, trackball, joystick, vibration generators, lights, etc. These and other user-interface components are coupled to the processor 602 as is known in the art.

The program storage/memory 604 includes operating systems for carrying out functions and applications associated with functions on the mobile computing arrangement 600. The program storage 604 may include one or more of read-only memory (ROM), flash ROM, programmable and/or erasable ROM, random access memory (RAM), subscriber interface module (SIM), wireless interface module (WIM), smart card, hard drive, computer program product, or other removable memory device. The storage/memory 604 may also include one or more hardware interfaces 623. The interfaces 623 may include any combination of operating system drivers, middleware, hardware abstraction layers, protocol stacks, and other software that facilitates accessing hardware such as user interface 618, alternate interface 616, and network hardware 606, 608.

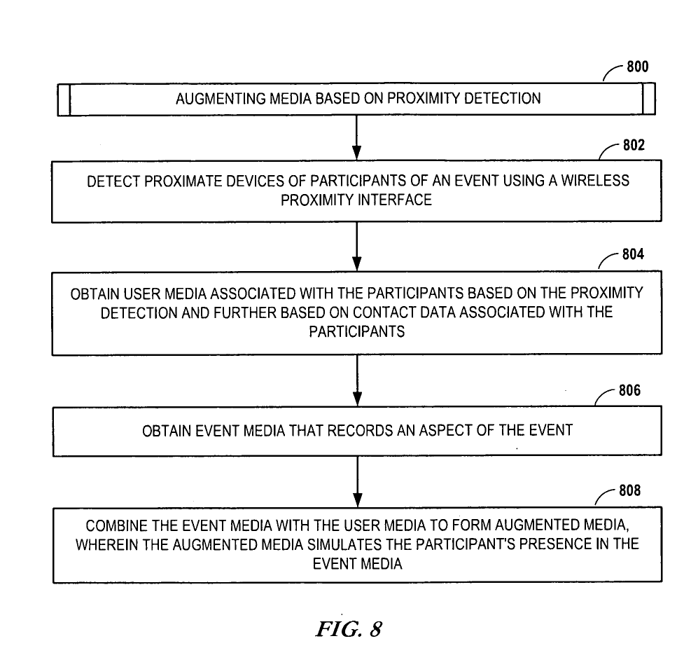

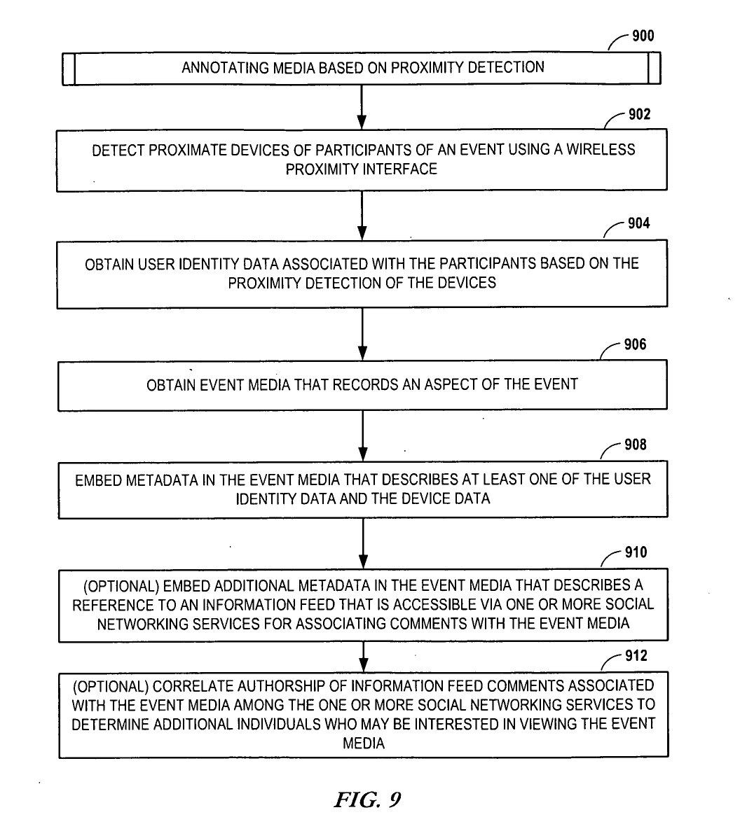

The storage/memory 604 of the mobile computing arrangement 600 may also include specialized software modules for performing functions according to example embodiments of the present invention, e.g., procedures shown in FIGS. 8-9. For example, the program storage/memory 604 includes a proximity detection module 624 that facilitates one or both of sending and receiving proximity data (e.g., device identifiers) that can further be used to determine user identity. For example, the proximity detection module 624 can repeatedly scan and enumerate proximate device identifiers via alternate interface 616. These identifiers can be passed to an identity search module 626 that searches for identity data based on device identifiers. The identity search module 626 may be configured to search a local contacts database 628 for device-to-identity mapping, and may also be configured to add such mappings to the database 628. The identity search module 628 may also be configured to directly obtain user identities via proximity detection module 624, such as by passing of vCard or similar identity data using near field communications.

The identity search module 626 may also be configured to perform online searches for identity data via a network service interface module 630. For example, social networking services 632 may be accessible via network(s) 615 that provide secure authorized access to device-to-identity mappings. Any of these mappings obtained via the services module 630 may be used for single use (e.g., connected to particular event) and/or stored in the contacts database 628 for long-term access. The service interface 630 may utilize locally stored user authentications to access the online social network services 632. The authenticated user identities may be used by the services 632 in deciding whether to share identity information of other users. For example, another user may need to explicitly add user of arrangement 600 to a list of service participants that are allowed to view the other user's profile data.

The data obtained by the identity search module 626 and/or contacts database may be utilized by a media enhancement module 634. The media enhancement module 634 extends the functionality of a media management module 636 that performs general-purpose media functions, such as media capture (e.g., via transducer 622), media download (e.g., via networks 615), media storage (e.g., to media storage 638), media retrieval, media rendering, etc. The media enhancement module 634 can receive device and identity data from proximity detection module 624 and/or identity search module 626 and add device and identity data as metadata to instances of captured/downloaded media. This media can be sent to sharing services 632, e.g., via service interface 630.

The media enhancement module 634 may also be able to for augmented media by combining supplementary media from proximate users with instances of captured/download images, as described in relation to FIGS. 1-2. The proximity detection module 624, identity search module 626, and/or service interface module 630 may be configured to directly or indirectly obtain user-specific pieces of media (e.g., photos of persons gotten from vCard data) in response to detecting those users via proximity detection module 624. This supplementary data may be added to the local contacts database 628, the media datastore 638, and or to network services 632. Similarly, the media enhancement module 634 may be configured to obtain templates as described in relation to FIG. 2 from any combination of proximity detection module 624, identity search module 626, and service interface module 630.

The mobile computing arrangement 600 of FIG. 6 is provided as a representative example of a computing environment in which the principles of the present invention may be applied. From the description provided herein, those skilled in the art will appreciate that the present invention is equally applicable in a variety of other currently known and future mobile and landline computing environments. For example, desktop and server computing devices similarly include a processor, memory, a user interface, and data communication circuitry. Thus, the present invention is applicable in any known computing structure where data may be communicated via a network.

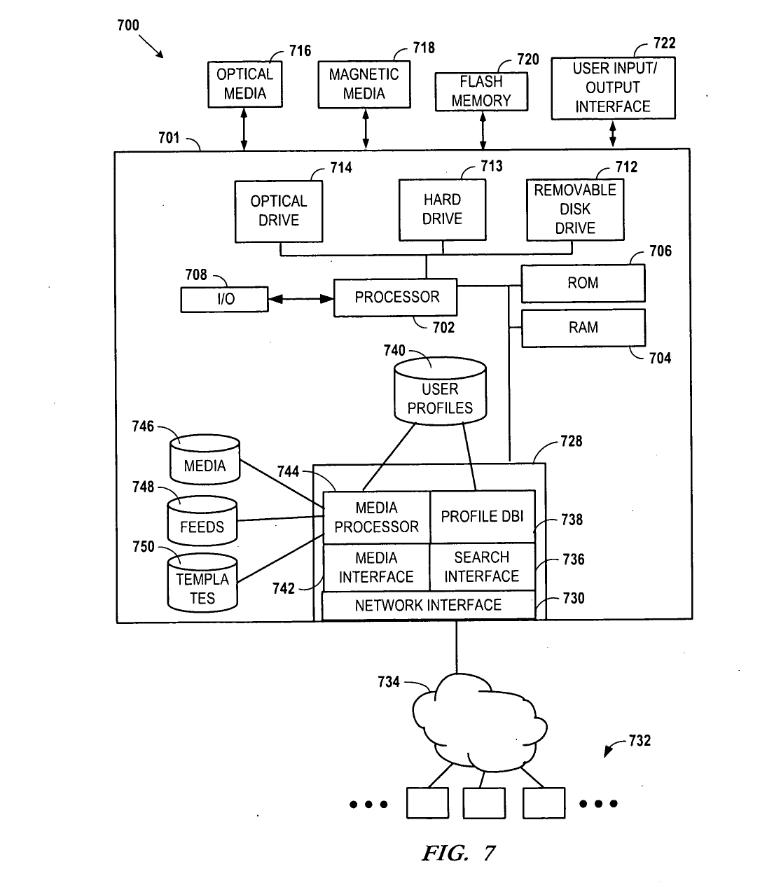

In reference now to FIG. 7, a block diagram provides details of a network service 700 that provides social networking services according to example embodiments of the invention. The service 700 may be implemented via one or more conventional computing arrangements 701. The computing arrangement 701 may include custom or general-purpose electronic components. The computing arrangement 701 include one or more central processors (CPU) 702 that may be coupled to random access memory (RAM) 704 and/or read-only memory (ROM) 706. The ROM 706 may include various types of storage media, such as programmable ROM (PROM), erasable PROM (EPROM), etc. The processor 702 may communicate with other internal and external components through input/output (I/O) circuitry 708. The processor 702 may include one or more processing cores, and may include a combination of general-purpose and special-purpose processors that reside in independent functional modules (e.g., chipsets). The processor 702 carries out a variety of functions as is known in the art, as dictated by fixed logic, software instructions, and/or firmware instructions.

The computing arrangement 701 may include one or more data storage devices, including removable disk drives 712, hard drives 713, optical drives 714, and other hardware capable of reading and/or storing information. In one embodiment, software for carrying out the operations in accordance with the present invention may be stored and distributed on optical media 716, magnetic media 718, flash memory 720, or other form of media capable of portably storing information. These storage media may be inserted into, and read by, devices such as the optical drive 714, the removable disk drive 712, I/O ports 708 etc. The software may also be transmitted to computing arrangement 701 via data signals, such as being downloaded electronically via networks, such as the Internet. The computing arrangement 701 may be coupled to a user input/output interface 722 for user interaction. The user input/output interface 722 may include apparatus such as a mouse, keyboard, microphone, touch pad, touch screen, voice-recognition system, monitor, LED display, LCD display, etc.

The service 700 is configured with software that may be stored on any combination of memory 704 and persistent storage (e.g., hard drive 713). Such software may be contained in fixed logic or read-only memory 706, or placed in read-write memory 704 via portable computer-readable storage media and computer program products, including media such as read-only-memory magnetic disks, optical media, flash memory devices, fixed logic, read-only memory, etc. The software may also placed in memory 706 by way of data transmission links coupled to input-output busses 708. Such data transmission links may include wired/wireless network interfaces, Universal Serial Bus (USB) interfaces, etc.

The software generally includes instructions 728 that cause the processor 702 to operate with other computer hardware to provide the service functions described herein, e.g., procedures shown in FIGS. 8-9. The instructions 728 may include a network interface 730 that facilitates communication with social networking clients 732 via a network 734 (e.g., the Internet). The network interface 730 may include a combination of hardware and software components, including media access circuitry, drivers, programs, and protocol modules. The network interface 730 may also include software modules for handling one or more common network data transfer protocols, such as HTTP, FTP, SMTP, SMS, MMS, etc.

The instructions 728 may include a search interface 736 for handling identity search request coming search components of the client devices (e.g., identity search module 626 in FIG. 6). The search request may be serviced using a profile database interface 738, which may search a locally-accessible user profile database 740 that maps device identifiers to user identities. The locally available database 740 may contain profiles of registered users of the service. The profile database interface 738 may also send/receive identity search requests to/from other providers via the network interface 730.

The instructions 728 may further include a media interface 742 capable of receiving media submissions from clients 732. These submissions may be for purposes of adding the media to personal pages of users, and the media may be stored in media database 746. The personal pages of the users may be accessed via a Web service of the media (not shown) that facilitates the primary social networking user interface functions of the service.

An enhanced media processor 744 may augment/supplement instances of media data passed to the service. The media processor 744 may add the “comments URL” (e.g., entry 316 in FIG. 3) to metadata of the media. The media processor 744 may also read metadata from the image to obtain URLs/URIs of other feeds that are embedded in media. These URIs/URLs may be stored in a feed database 748 that is linked to media in the media database 746. In this way, the service 700 may be able to fetch comments from other social network services based on the comments URL tag of images. These comments could also be shown to the viewers of personal Web pages of the service 700.

The media processor 744 may also facilitate combining supplementary media with primary media, such as described in relation to FIGS. 1 and 2. For example, the media processor 744 may obtain supplementary data from any combination of the profile interface 738, profiles database 740, media database 746, and clients 732. This may be combined with primary media obtained from any combination of the media interface 742, media database 746, and clients 732. The media processor 744 may also access a templates database 750 that provides additional media augmentation options. These templates 750 can be communicated to clients 732 for local use, and can be used by the service 700 for its own processing at the media processor 744.

For purposes of illustration, the operation of the service 700 is described in terms of functional circuit/software modules that interact to provide particular results. Those skilled in the art will appreciate that other arrangements of functional modules are possible. Further, one skilled in the art can readily implement such described functionality, either at a modular level or as a whole, using knowledge generally known in the art. The computing structure 701 is only a representative example of network infrastructure hardware that can be used to provide image enhancement and social networking services as described herein. Generally, the functions of the computing service 700 can be distributed over a large number of processing and network elements, and can be integrated with other services, such as Web services, gateways, mobile communications messaging, etc. For example, some aspects of the service 700 may be implemented in user devices (and/or intermediaries such as servers 204-207 shown in FIG. 2) via client-server interactions, peer-to-peer interactions, distributed computing, etc.

In reference now to FIG. 8, a flowchart illustrates a procedure 800 for augmenting media based on proximity detection according to an example embodiment of the invention. The procedure involves detecting 802 proximate devices of participants of an event using a wireless proximity interface. User media associated with the participants is obtained 804 based on the proximity detection and further based on contact data associated with the participants. Event media is obtained 806 that records an aspect of the event. The event media is combined 808 with the user media to form augmented media, wherein the augmented media simulates the participant's presence in the event media.

In reference now to FIG. 9, a flowchart illustrates a procedure 900 for annotating media based on proximity detection according to an example embodiment of the invention. The procedure involves detecting 902 proximate devices of participants of an event using a wireless proximity interface. User identity data of the participants is obtained 904 based on the proximity detection of the devices, and event media is obtained 906 that records an aspect of the event. Metadata is embedded 908 in the event media that describes at least one of the user identity data and the device data.

Optionally, the procedure 900 may involve embedding 910 additional metadata in the event media that describes a reference to an information feed that is accessible via a social networking service for associating comments with the event media. Another optional aspect involves correlating 912 authorship of information feed comments associated with the event media among the one or more social networking services to determine additional individuals who may be interested in viewing the event media.

The foregoing description of the example embodiments of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather determined by the claims appended hereto.

What is claimed is:

1. An apparatus, comprising:
a processor configured with executable instructions that cause the apparatus to:
detect proximate devices of participants of an event using a wireless proximity interface;
obtain user media associated with the participants based on the proximity detection and further based on contact data associated with the participants;
obtain event media that records an aspect of the event; and
combine the event media with the user media to form augmented media, wherein the augmented media simulates the participant's presence in the event media.

2. The apparatus of claim 1, wherein the event media comprises a digital photograph of the event, and wherein the user media comprises digital images of the participant that is obtained independently of the digital photograph.

3. The apparatus of claim 2, wherein the instructions further cause the apparatus to obtain a template that supplements one or more of the digital images of the participants.

4. The apparatus of claim 1, wherein the instructions further cause the apparatus to embed metadata into at least one of the event media and the augmented media, wherein the metadata is obtained from at least one of the proximity detection and the contact data.

5. The apparatus of claim 4, wherein the metadata further comprises a computer-processable reference to an information feed that facilitates associating user-editable comments with at least one of the event media and the augmented media.

6. The apparatus of claim 1, wherein obtaining the user media comprises obtaining the user media directly from the proximate devices using near field communications.

7. The apparatus of claim 1, wherein obtaining the user media comprises obtaining the user media from a network service.

8. A method, comprising:
detecting proximate devices of participants of an event via a wireless proximity device;
obtaining, via a processing device, user media associated with the participants based on the proximity detection and further based on contact data associated with the participants;
obtaining event media that records an aspect of the event via the processing device; and
combining the event media with the user media to form augmented media, wherein the augmented media simulates the participant's presence in the event media.

9. The method of claim 8, wherein the event media comprises a digital photograph of the event, and wherein the user media comprises digital images of the participant that is obtained independently of the digital photograph.

10. The method of claim 9, further comprising obtaining a template that supplements one or more of the digital images of the participants.

11. The method of claim 8, further comprising embedding metadata into at least one of the event media and the augmented media, wherein the metadata is obtained from at least one of the proximity detection and the contact data.

12. The method of claim 11, wherein the metadata further comprises a computer-processable reference to an information feed that facilitates associating user-editable comments with at least one of the event media and the augmented media.

13. The method of claim 8, wherein obtaining the user media comprises obtaining the user media directly from the proximate devices using near field communications.

14. The method of claim 8, wherein obtaining the user media comprises obtaining the user media from a network service.

15. A computer-readable storage medium encoded with instructions that, when executed by an apparatus, perform:
detecting proximate devices of participants of an event using a wireless proximity interface of the apparatus;
obtaining user media associated with the participants based on the proximity detection and further based on contact data associated with the participants;
obtaining event media that records an aspect of the event; and
combining the event media with the user media to form augmented media, wherein the augmented media simulates the participant's presence in the event media.

16. The computer-readable storage medium of claim 15, wherein the event media comprises a digital photograph of the event, and wherein the user media comprises digital images of the participant that is obtained independently of the digital photograph.

17. The computer-readable storage medium of claim 16, further comprising obtaining a template that supplements one or more of the digital images of the participants.

18. The computer-readable storage medium of claim 15, further comprising embedding metadata into at least one of the event media and the augmented media, wherein the metadata is obtained from at least one of the proximity detection and the contact data, and wherein the metadata further comprises a computer-processable reference to an information feed that facilitates associating user-editable comments with at least one of the event media and the augmented media.

19. The computer-readable storage medium of claim 15, wherein obtaining the user media comprises obtaining the user media directly from the proximate devices using near field communications.

20. The computer-readable storage medium of claim 15, wherein obtaining the user media comprises obtaining the user media from a network service.
